(19) United States
(12) Patent Application Publication
(10) Pub. No.: US 2016/0175770 A1
(43) Pub. Date: Jun. 23, 2016

(54) METHOD AND SYSTEM FOR CARBON DIOXIDE DESORPTION

(71) Applicant: General Electric Company, Schenectady, NY (US)

(72) Inventors: Irina Pavlovna Spiry, Gloversville, NY (US); Benjamin Rue Wood, Niskayuna, NY (US); John Brian McDermott, Rexford, NY (US); Surinder Prabhjot Singh, Schenectady, NY (US); Sarah Elizabeth Genovese, Delmar, NY (US)

(21) Appl. No.: 14/578,606

(22) Filed: Dec. 22, 2014

(51) Int. Cl. B01D 53/62; B01D 53/14; B01D 19/00; B01D 53/78

(52) U.S. Cl. CPC B01D 53/62; B01D 53/78; B01D 53/1425; B01D 19/0036; B01D 53/1475; B01D 2252/204; B01D 2257/504

(57) ABSTRACT

A method for separating carbon dioxide (CO₂) from a fluid stream comprising CO₂ and a liquid solvent is provided. The method includes receiving the fluid stream at a first flashing means to obtain a first CO₂ stream and a first CO₂ lean fluid stream enriched in the liquid solvent in comparison with the fluid stream. Further, the method also includes receiving the first CO₂ lean fluid stream at a second flashing means to obtain a second CO₂ stream and a second CO₂ lean fluid stream that is enriched in the liquid solvent in comparison with the first CO₂ lean fluid stream.

### BACKGROUND

The present invention relates, generally, to the field of carbon dioxide (CO₂) separation and, more particularly, to a method and system for CO₂ desorption from a fluid stream.

Processes such as natural gas processing, steam reforming of methane, enhanced oil recovery gas recycling, and power generation typically produce CO₂ as a byproduct. It may be desirable to capture or otherwise separate the CO₂ from the gas mixture to prevent the release of CO₂ into the environment.

Many current CO₂ absorption processes involve aqueous amine-based solvents where the solvent is brought in contact with the exhaust gases to capture CO₂ from them. In addition, experiments are in progress to test the efficacy of non-aqueous aminosiloxane solvents for CO₂ capture. These processes result in primarily two different streams—a clean gas stream and a CO₂ rich solvent stream. In many current setups, the CO₂ rich solvent stream is recovered and regenerated.

To reduce the volumes of solvent being utilized for CO₂ recovery processes, desorption systems are also utilized at the end of an absorption cycle to separate CO₂ and recover the solvent from the CO₂ rich solvent stream. Examples of desorption systems include, but are not limited to, stripping columns, and the like. However systems that include absorption as well as desorption processes, are typically capital intensive and are complex for maintenance.

Further, amine solvent based systems may sometimes not exhibit a high level of thermal stability, and this can result in additional chemical stabilizer costs. Also, the use of amine-based solvents can lead to wear and tear of various components in the system, and this can also add maintenance and replacement costs.

Hence, there is a need for an efficient and cost effective method to separate CO₂ from solvent streams.

### BRIEF DESCRIPTION

In accordance with one aspect of the present invention, a method for separating carbon dioxide (CO₂) from a fluid stream comprising CO₂ and a liquid solvent is provided. The method includes receiving the fluid stream at a first flashing means to obtain a first CO₂ stream and a first CO₂ lean fluid stream enriched in the liquid solvent in comparison with the fluid stream. Further, the method also includes receiving the first CO₂ lean fluid stream at a second flashing means to obtain a second CO₂ stream and a second CO₂ lean fluid stream that is enriched in the liquid solvent in comparison with the first CO₂ lean fluid stream.

In accordance with another aspect of the present invention a system for separating carbon dioxide (CO₂) from a fluid stream comprising CO₂ and a liquid solvent is provided. The method includes a first flashing means that is configured to receive the fluid stream and separate the fluid stream to obtain a first CO₂ stream and a first CO₂ lean fluid stream. The first CO₂ lean fluid stream is enriched in the liquid solvent in comparison with the fluid stream. Further, the system also includes a second flashing means in fluid communication with the first flashing means. The second flashing means is configured to receive the first CO₂ lean fluid stream to separate the first CO₂ lean fluid stream to obtain a second CO₂ stream and a second CO₂ lean fluid stream. The second CO₂ lean fluid stream is enriched in the liquid solvent in comparison with the first CO₂ lean fluid stream.

In accordance with yet another aspect of the present invention, a method for separating carbon dioxide (CO₂) from a gas stream is provided. The method includes contacting a first liquid solvent stream with the gas stream in an absorber. The first liquid solvent stream comprises a liquid solvent. Further, the method includes reacting at least a portion of the CO₂ in the gas stream with the first liquid solvent stream to obtain a fluid stream and a clean gas stream. The clean gas stream has reduced CO₂ in comparison with the initial gas stream. On the other hand, the fluid stream includes CO₂ and the liquid solvent. The method also includes heating the fluid stream in a first flashing means that is in fluid communication with the absorber to obtain a first CO₂ stream and a first CO₂ lean fluid stream. The first CO₂ lean fluid stream is enriched in the liquid solvent in comparison with the fluid stream. Furthermore, the method includes heating the first CO₂ lean fluid stream in a second flashing means that is in fluid communication with the first flashing means to obtain a second CO₂ stream and a second CO₂ lean fluid stream. The second CO₂ lean fluid stream is enriched in the liquid solvent in comparison with the first CO₂ lean fluid stream.

Other embodiments, aspects, features, and advantages of the invention will become apparent to those of ordinary skill in the art from the following detailed description, the accompanying drawings, and the appended claims.

### BRIEF DESCRIPTION OF THE DRAWING FIGURES

These and other features, aspects, and advantages of the present invention will become better understood when the following detailed description is read with reference to the accompanying drawings in which like characters represent like parts throughout the drawings, wherein:

FIG. 1 is a schematic illustration of a system for CO₂ separation from a gas stream, in accordance with one embodiment of the invention;

FIG. 2 is a schematic illustration of a system for CO₂ separation from a fluid stream, in accordance with one embodiment of the invention; and

FIG. 3 is a schematic illustration of a system for CO₂ separation from a fluid stream, in accordance with yet another embodiment of the invention.

### DETAILED DESCRIPTION

As discussed in detail below, embodiments of the present invention include methods and systems suitable for CO₂ separation. As discussed in detail below, embodiments of the present invention include methods and systems for high efficiency and cost-effective CO₂ separation from a fluid stream that includes liquid solvents and CO₂. The term “fluid stream comprising CO₂” refers to a fluid system wherein CO₂ can be dissolved in the solvent and/or reacted with the solvent to form reaction products. In particular embodiments, the methods and systems for CO₂ separation include an absorber configured to absorb CO₂ from a gas stream and a desorption unit including a plurality of flashing means. The methods and systems may also include other components such as a separation unit to enable aerosol disengagement. This may advantageously result in one or more of reduced materials and capital cost, increased efficiency, a simplified CO₂ capture process, or a potential reduction in the overall footprint of the system.

Approximating language, as used herein throughout the specification and claims, may be applied to modify any quantitative representation that could permissibly vary without resulting in a change in the basic function to which it is related. Accordingly, a value modified by a term or terms, such as “about”, “substantially”, and “approximately” is not limited to the precise value specified. In some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

In the following specification and the claims, the singular forms “a”, “an” and “the” include plural referents unless the context clearly dictates otherwise. As used herein, the term “or” is not meant to be exclusive and refers to at least one of the referenced components being present and includes instances in which a combination of the referenced components may be present, unless the context clearly dictates otherwise.

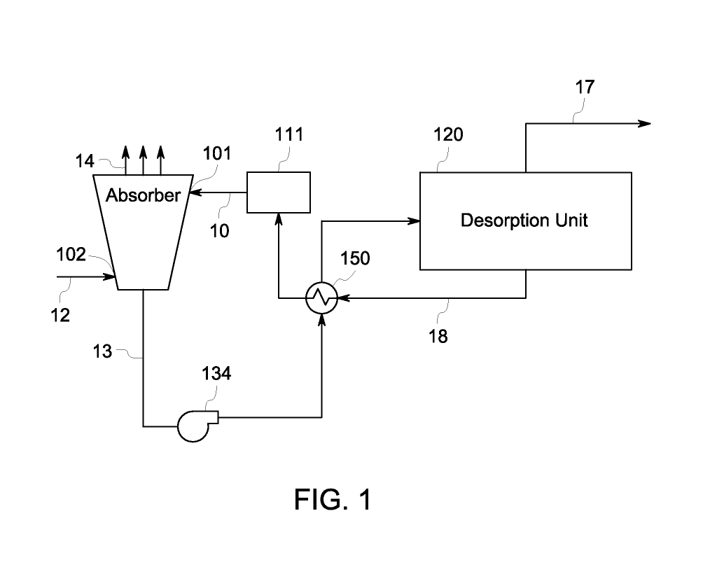

In some embodiments, as shown in FIGS. 1-3, a method for separating carbon dioxide (CO₂) from a gas stream 12 is provided. The term “gas stream” as used herein refers to a gas mixture, which may further include one or both of solid and liquid components. In some embodiments, the gas stream 12 is a product from a combustion process, a gasification process, a landfill, a furnace, a steam generator, a boiler, or combinations thereof. In one embodiment, the gas stream 12 includes a gas mixture emitted as a result of the processing of fuels, such as, natural gas, biomass, gasoline, diesel fuel, coal, oil shale, fuel oil, tar sands, and combinations thereof. In some embodiments, the gas stream 12 includes a gas mixture emitted from a gas turbine. In some embodiments, the gas stream 12 includes syngas generated by gasification or a reforming plant. In certain embodiments, the syngas generated by gasification plants may be processed before being introduced as the gas stream 12. In some embodiments, the gas stream 12 includes flue gas. In particular embodiments, the gas stream 12 includes a gas mixture emitted from a coal or natural gas-fired power plant.

As noted earlier, the gas stream 12 includes carbon dioxide. In some embodiments, the gas stream 12 further includes one or more of nitrogen, oxygen, or water vapor. In some embodiments, the gas stream 12 further includes impurities or pollutants, examples of which include, but are not limited to, nitrogen oxides, sulfur oxides, carbon monoxide, hydrogen sulfide, unburnt hydrocarbons, particulate matter, and combinations thereof. In some embodiments, the gas stream 12 is substantially free of the impurities or pollutants. In some embodiments, the gas stream 12 includes nitrogen, oxygen, and carbon dioxide. In some embodiments, the gas stream 12 includes nitrogen and carbon dioxide. In some embodiments, the gas stream 12 includes carbon monoxide. In some embodiments, the gas stream 12 includes carbon monoxide, carbon dioxide, and hydrogen sulphide. In some embodiments, the gas stream 12 includes syngas. In some embodiments, the gas stream 12 includes natural gas that contains various amounts of CO₂.

In some embodiments, the amount of impurities or pollutants in the gas stream 12 is greater than about 50 mole percent, based on total gaseous components present in the gas stream 12. In some embodiments, the amount of impurities or pollutants in the gas stream 12 is less than about 50 mole percent based on the total gaseous components present in the gas stream 12. In some embodiments, the amount of impurities or pollutants in the gas stream 12 is in a range from about 10 mole percent to about 20 mole percent. In some embodiments, the amount of impurities or pollutants in the gas stream 12 is less than about 5 mole percent.

In some embodiments, the method may further include receiving the gas stream 12, from a hydrocarbon processing, combustion, gasification or a similar power plant (not shown), in the absorber 110 via at least one inlet 102, as indicated in FIG. 1. In some embodiments, the gas stream 12 may be further subjected to one or more processing steps (for example, removing water vapor, impurities, and the like) before providing the gas stream 12 to the absorber 110.

The gas stream 12, in certain embodiments, is brought in contact with a first liquid solvent stream 10 in the absorber 110. The first liquid solvent stream 10 is introduced in the absorber 110 through at least one inlet 101. In some embodiments, as indicated in FIG. 1, the inlet 102 for the gas stream 12 is located in a lower region of the absorber 110, relative to the inlet 101 for the first liquid solvent stream 10. In some embodiments, the gas stream 12 is advantageously provided to the absorber 110 at a location such that an induced countercurrent flow exposes the gas stream, when it has the lowest CO₂ concentration, to the freshest liquid solvent. Further, the gas stream with the highest CO₂ concentration is exposed to the liquid solvent stream that has substantially reacted with the CO₂.

In some embodiments, the flow rate of the gas stream 12 entering the absorber 110 may be chosen to enable the desired CO₂ removal, for example, to provide adequate liquid to gas ratio to reduce the CO₂ level in the gas stream to a desired value. In some embodiments, the inlet pressure may depend on the design and operating conditions of the absorber and the process conditions of the gas to be treated as described below.

The first liquid solvent stream 10 and the gas stream 12 are brought in contact with each other such that a chemical reaction between the liquid solvent and the CO₂ can occur. In some embodiments, carbamate is formed as a result of the chemical reaction between the liquid solvent and CO₂ from the gas stream.

In some embodiments, the absorber 110 is configured to operate under the desired reaction conditions (for example, temperature and pressure) depending on the specific liquid solvent utilized. In some embodiments, the absorber 110 may be configured to operate at atmospheric pressure. In some embodiments, the absorber 110 may be configured to operate at elevated pressures up to about 50 atm. In some embodiments, the absorber 110 may be configured to operate at a temperature in a range from about 20 degrees Celsius to about 160 degrees Celsius. Non-limiting examples of suitable absorbers may include a packed tower, a tray tower, a spray tower, any other known gas-liquid contacting systems, or combinations thereof. Moreover, while a vertical absorber is depicted in FIGS. 1-3, it is to be understood that a horizontally-oriented absorber might alternatively be used.

As described in detail below, the liquid solvent, in accordance with the embodiments of the invention, is in a liquid state. Furthermore, additional carrier co-solvents may be added to the liquid solvent to form the first liquid solvent stream 10. The liquid solvent, along with being in a liquid form, is itself capable of chemically reacting with the CO₂ in the gas stream to form carbamate. The additional carrier co-solvent is selected to solubilize the liquid solvent and reaction product of the liquid solvent and CO₂ from the gas stream 12.

In some embodiments, the liquid solvent includes a monomer, an oligomer, a polymer, or combinations thereof. In some embodiments, the liquid solvent includes an aminosiloxane moiety. Suitable examples of liquid solvents are described in co-pending patent applications Ser. No. 12/343,905 (Genovese et al), filed on 24 Dec. 2008; Ser. No. 12/512,577 (Perry et al), filed on 30 Jul. 2009; Ser. No. 12/512,105 (Perry et al), filed on 30 Jul. 2009; Ser. No. 13/332,843 (O'Brien et al), field on 21 Dec. 2011; Ser. No. 12/817,276 (Perry et al), filed on 17 Jun. 2010; Ser. No. 13/217,408 (Davis et al), filed on 25 Aug. 2011, all of which are incorporated by reference in their entirety, so long as not directly contradictory with the teachings herein.

In some embodiments, the liquid solvent includes an amino siloxane moiety having a formula (I):

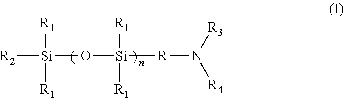

wherein n is an integer more than 1, R is a C₁-C₆ aliphatic radical; R₁ is independently at each occurrence a C₁-C₁₀ aliphatic or aromatic radical; R₂ is R₁ or RNR₃R₄, wherein R₃ and R₄ are independently at each occurrence a bond, hydrogen, or a C₁-C₁₀ aliphatic radical.

As used herein, the term “aromatic radical” refers to an array of atoms having a valence of at least one comprising at least one aromatic group. The array of atoms having a valence of at least one comprising at least one aromatic group may include heteroatoms such as nitrogen, sulfur, selenium, silicon and oxygen, or may be composed exclusively of carbon and hydrogen. As used herein, the term “aromatic radical” includes, but is not limited to, phenyl, pyridyl, furanyl, thienyl, naphthyl, phenylene, and biphenyl radicals. As noted, the aromatic radical contains at least one aromatic group. The aromatic group is invariably a cyclic structure having 4a+2 “delocalized” electrons where “a” is an integer equal to 1 or greater, as illustrated by phenyl groups (a=1), thienyl groups (a=1), furanyl groups (a=1), naphthyl groups (a=2), azulenyl groups (a=2), anthraceneyl groups (a=3) and the like. The aromatic radical may also include nonaromatic components. For example, a benzyl group is an aromatic radical that comprises a phenyl ring (the aromatic group) and a methylene group (the nonaromatic component). Similarly a tetrahydronaphthyl radical is an aromatic radical comprising an aromatic group (C₆H₃) fused to a nonaromatic component —(CH₂)₄—. For convenience, the term “aromatic radical” is defined herein to encompass a wide range of functional groups such as alkyl groups, alkenyl groups, alkynyl groups, haloalkyl groups, haloaromatic groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylphenyl radical is a C₇ aromatic radical comprising a methyl group, the methyl group being a functional group which is an alkyl group. Similarly, the 2-nitrophenyl group is a C₆ aromatic radical comprising a nitro group, the nitro group being a functional group. The term “a C₃-C₁₀ aromatic radical” includes aromatic radicals containing at least three but no more than 10 carbon atoms. The aromatic radical 1-imidazolyl (C₃H₂N₂—) represents a C₃ aromatic radical. The benzyl radical (C₇H₇—) represents a C₇ aromatic radical.

As used herein the term “aliphatic radical” refers to an organic radical having a valence of at least one consisting of a linear or branched array of atoms, which is not cyclic. Aliphatic radicals are defined to comprise at least one carbon atom. The array of atoms comprising the aliphatic radical may include heteroatoms such as nitrogen, sulfur, silicon, selenium and oxygen or may be composed exclusively of carbon and hydrogen. For convenience, the term “aliphatic radical” is defined herein to encompass, as part of the “linear or branched array of atoms which is not cyclic” a wide range of functional groups such as alkyl groups, alkenyl groups, alkynyl groups, haloalkyl groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylpent-1-yl radical is a C₆ aliphatic radical comprising a methyl group, the methyl group being a functional group which is an alkyl group. Similarly, the 4-nitrobut-1-yl group is a C₄ aliphatic radical comprising a nitro group, the nitro group being a functional group. An aliphatic radical may be a haloalkyl group which comprises one or more halogen atoms which may be the same or different. Halogen atoms include, for example; fluorine, chlorine, bromine, and iodine. Aliphatic radicals comprising one or more halogen atoms include the alkyl halides trifluoromethyl, bromodifluoromethyl, chlorodifluoromethyl, hexafluoroisopropylidene, chloromethyl, difluorovinylidene, trichloromethyl, bromodichloromethyl, bromoethyl, 2-bromotrimethylene (e.g., —CH₂CHBrCH₂—), and the like. By way of further example, a C₁-C₁₀ aliphatic radical contains at least one but no more than 10 carbon atoms. A methyl group (i.e., CH₃—) is an example of a C₁ aliphatic radical. A decyl group (i.e., CH₃(CH₂)₉—) is an example of a C₁₀ aliphatic radical.

In some embodiments, the liquid solvent includes an aminosiloxane having a formula (II) or a mixture of aminosiloxanes having structure (II) where the value of x is varied from 0 to 10:

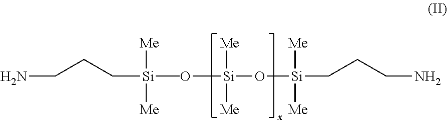

In some other embodiments, the liquid solvent includes isomers (structure (III) and structure (IV)) of aminosiloxane having structure (II) or a mixture of amino siloxanes having structure (III) or (IV) where the value of x is varied from 0 to 10:

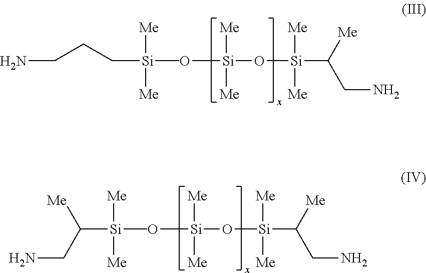

Further, the liquid solvent includes a mixture of aminosiloxanes having a structure (I), or (II), or (III), or (IV) and one or more co-solvents. In some embodiments, examples of the additional co-solvents include, but are not limited to, triethylene glycol (TEG) and the like.

In some embodiments, the liquid solvent having structure (I), or (II), or (III), or (IV) may be mixed with one or more hydroxy-containing solvents. As used herein, the phrase “hydroxy-containing solvent” means a solvent that has one or more hydroxy groups. The hydroxy-containing solvent also desirably has a low vapor pressure, e.g., of from about 0.001 to about 30 mm/Hg at 100° C., so that minimal loss of the hydroxy-containing solvent occurs via evaporation. Suitable hydroxy-containing solvent are those that do not substantially chemically react with CO₂, but rather, serve as a medium for CO₂ transfer to the amino siloxane solvent present in the liquid stream 10. As a result, the hydroxy-containing solvents are expected to be capable of increasing the reaction rate, e.g., by increasing the mass transfer rate, of CO₂ and aminosiloxanes, and also to reduce, or substantially prevent, excessive viscosity build-up when the aminosiloxane from the liquid stream 10 reacts with CO₂ from the gas stream 12. Advantageously, many suitable hydroxyl-containing solvents may be recycled, along with the amino siloxane, if desired.

Examples of suitable hydroxy-containing solvents include, but are not limited to, those comprising one or more hydroxyl groups, such as, glycols and hydroxylated silicones. Suitable glycols may include, for example, trimethylolpropane, glycerol, ethylene glycol, diethylene glycol, triethylene glycol and tetraethylene glycol, to name a few. Suitable hydroxylated silicones include, for example, 1,3-bis(3-hydroxypropyl)tetramethyldisiloxane, or the hydrosilylation reaction product of 1,1,3,3-tetramethyldisiloxane and trimethylolpropane allylether. Hydroxy compounds may also be in the form of phenols such as eugenol, isoeugenol, 2-allyl-6-methylphenol and the like.

In certain embodiments, the liquid solvent stream 10 may comprise an amount of water, e.g., so that all water need not be removed from the process stream in order to utilize the absorbent and methods. Indeed, in some embodiments, water is desirably present and in such embodiments, can assist in the solubilization of reaction products.

Optionally, the liquid solvent stream 10 may also include other components, such as, e.g., oxidation inhibitors to increase the oxidative stability and anti-foaming agents. The liquid solvent stream 10 may also include corrosion inhibiters. The use of oxidation inhibitors, also called antioxidants, can be especially advantageous in those embodiments of the invention wherein the functional groups comprise amine groups.

In certain embodiments, the weight ratio of the aminosiloxane in the liquid stream 10 and the co-solvent may be 10:90. In certain embodiments, the weight fraction of aminosiloxane in the liquid solvent may vary from 10% wt to 95% wt. On the other hand, the weight fraction of the co-solvent may vary from 90% wt-5% wt. In one embodiment, the weight fraction of aminosiloxane in the liquid stream 10 may vary from 30% wt to 80% wt, whereas the co-solvent weight fraction may vary from 70% wt-20% wt. In another embodiment, the weight fraction of aminosiloxane in the liquid stream 10 may vary from 50% wt to 70% wt, whereas the co-solvent weight fraction may vary from 50% wt-30% wt.

In another exemplary embodiment, a mixture of an amino silicone with a structure shown in formula (II) and “x” having an average value of 0.6-1.2 may be blended with triethylene glycol (TEG) in a weight ratio of 60:40 to generate the first liquid solvent stream 10.

In some embodiments, the method may further include a step of receiving the first liquid solvent stream 10 in the absorber 110 via at least one inlet 101. In some embodiments, the system 100 may further include a liquid solvent source 111 in fluid communication with the inlet 101 of the absorber 110, as indicated in FIG. 1. In some embodiments, the method may include providing a plurality of first liquid solvent streams 10 via a plurality of inlets 101 (not specifically shown) in the absorber 110.

In some embodiments, the method further includes reacting at least a portion of CO₂ in the gas stream 12 with the liquid solvent to form a fluid stream 13 and a clean gas stream 14, as indicated in FIG. 1. The term “fluid stream” as used herein refers to a reaction product of liquid solvent and CO₂. In some embodiments, the fluid stream 13 includes a carbamate moiety, a bicarbonate moiety, or combinations thereof. In an embodiment, the fluid stream 13 is in a substantially liquid state.

In some embodiments, the weight fraction CO₂ captured by the liquid solvent is greater than or equal to 1%. The weight fraction percent value depends on a plurality of factors that include, but are not limited to, gas stream flow rate, chemical composition of the liquid solvent stream 10, composition of the gas stream 12, and the like.

In some embodiments, the method further includes forming the clean gas stream 14 in the absorber 110, as indicated in FIG. 1. The term “clean gas stream” as used herein refers to a gas stream having CO₂ content lower than that of the gas stream 12. In some embodiments, the clean gas stream 14 has a CO₂ content that is less than about 60 percent by volume of the CO₂ content in the gas stream 12. In some embodiments, the clean gas stream 14 has a CO₂ content that is less than about 40 percent by volume of the CO₂ content in the gas stream 12. In some embodiments, the clean gas stream 14 has a CO₂ content that is less than about 10 percent by volume of the CO₂ content in the gas stream 12.

In some embodiments, the method further includes forming the fluid stream 13, wherein CO₂ from the gas stream 12 is chemically reacted with the liquid solvent in the absorber 110, to form the fluid stream 13. The term “fluid stream” as used herein refers to a gas stream carrying or transporting the CO₂ from the gas stream 12. In some embodiments, in addition to the CO₂ from the gas stream 12, the fluid stream 13 may further include unreacted CO₂ gas, unreacted liquid sorbent droplets, or combinations thereof.

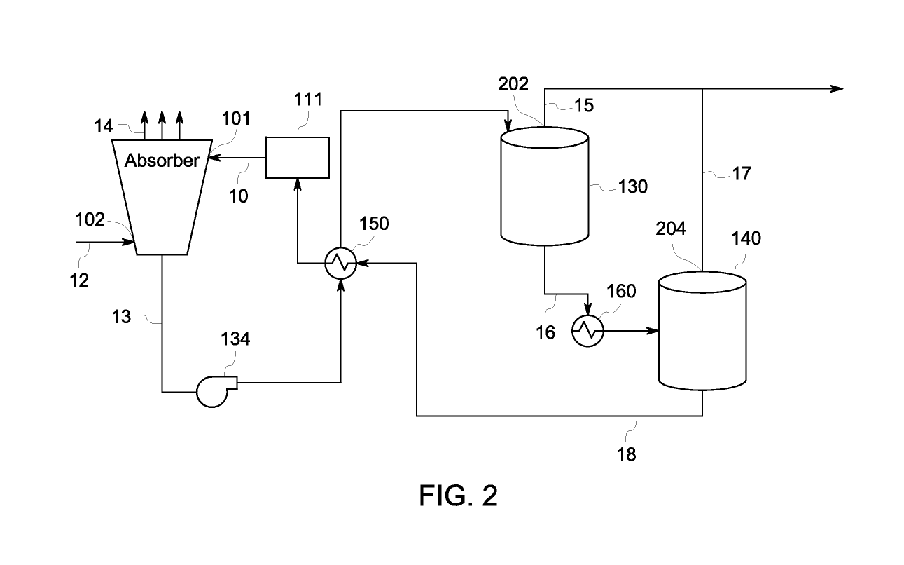

The method further includes receiving the fluid stream 13 in a desorption unit 120 that is configured to separate CO₂ from the liquid solvent and obtain CO₂ lean liquid solvent streams. An embodiment of desorption unit 120 is illustrated in FIG. 2. The term “CO₂-lean solvent streams” as used herein refers to a gas stream having CO₂ content (in the form of carbamate, pure CO₂ gas, or both) lower than the CO₂ content in the fluid stream 13.

The desorption unit 120 includes a first flashing means 130 and a second flashing means 140. The first and second flashing means are configured to separate CO₂ and the liquid solvent present in the fluid stream 13 and produce separate CO₂ rich streams and separate CO₂ lean solvent streams.

The term “flashing means” is used herein according to its ordinary meaning and generally refers to a vessel configured and operated to separate a vapor phase from a liquid phase, which is substantially free of reflux from an external condenser or re-boiled fluid from an external heater. In some embodiments, separation may be achieved using one or more flashing means operated such that substantially no externally supplied heat is input into the flashing means during the separating step. Flashing means described herein may be operated, in some instances, essentially adiabatically, while, in other cases, they may be operated essentially isothermally. Non-limiting examples of devices or systems suitable for flashing means include flash drums, knock-out drums, CSTR (continuous stirred tank reactor) and compressor suction drums.

Each flashing means 130 and 140 in the desorption unit 120 may be coupled to heat exchangers at inlet ports for the fluid entering into the flashing means to be heated before it settles in the flashing means. The temperature and/or pressure of the first and second flashing means 130 and 140 can be selected such that effective separation of the liquid solvent and CO₂ may be achieved. In some embodiments, the first flashing means (e.g., flashing means 130 in FIG. 2) is operated at a first pressure and a first temperature, and the second flashing means downstream of the first flashing means (e.g., flashing means 140 in FIG. 2) is operated at a second pressure and a second temperature. The flashing means 130 and 140 may thus be operated at different temperatures and/or pressures to achieve enhanced separation in sequential steps.

In some embodiments, a first heat exchanger 150 and a second heat exchanger 160 (as indicated in FIGS. 1 and 2) are configured to heat the fluid stream 13 and the first CO₂ lean fluid stream 16 to the first temperature and the second temperature. The first heat exchanger 150 is disposed along the fluid conduits that fluidly couple the absorber 110 with the first flashing means 130. Similarly, the second heat exchanger 160 is placed along the fluid conduits that fluidly couple the first flashing means 130 with the second flashing means 140.

In some embodiments, the temperature of the flashing means (e.g., flashing means 130, flashing means 140) is higher than the temperature of the fluid streams fed to each of the flashing means (e.g., fluid stream 13 and the first CO₂ lean fluid stream 16, respectively), while the pressure of the flashing means 130 and 140 is substantially lower, substantially the same, or substantially higher to the pressure of the fed fluid. In some embodiments, the pressure of the flashing means 130 and 140 may be higher than the pressure of the fluid stream fed to the flashing means 130 and 140 while the temperatures of the flashing means 130 and 140 are substantially lower, substantially the same, or substantially higher than that of the fed fluid streams. In some cases, the first and second pressures and/or the first and second temperatures of the flashing means are lower than the pressure and temperature of the fluid stream fed to the flashing means.

In some embodiments, the first flashing means 130 and/or the second flashing means 140 may be operated at ambient temperature and/or ambient pressure. In some embodiments, the pressure in the first and second flashing means 130 and 140 is greater than or equal to 1 atm. In some embodiments, the pressure in the first and second flashing means 130 and 140 is, independently, in a range from about 2 atm to about 20 atm.

In some embodiments, after the step of reacting the gas stream 12 with the first liquid solvent stream 10, the fluid stream 13 may be pressurized in a pump 134 that delivers the fluid stream 13, under pressure, to the desorption unit 120. In some embodiments, by delivering the fluid stream 13 under pressure, the compression duty needed for CO₂ desorption may be reduced. In some embodiments, the pressure of the fluid stream 13 is suitable for injection into the desorption unit (that is, greater than the desorption pressure). In some embodiments, when the absorber outlet port is located upstream of the desorption unit 120, a pump, such as the pump 134, may not be required to direct the fluid stream 13 to the desorption unit 120.

In some embodiments, the first and second CO₂ lean streams 16 and 18 may be introduced by themselves, after cooling, to the absorber 110, to react with additional CO₂ from the gas stream 12, thereby forming more CO₂-bound material in the fluid stream 13 in a closed loop process. In some other embodiments, the first and second CO₂ lean streams 16 and 18 may be introduced in a fresh first liquid solvent stream; or may be added to the absorber 110 as a separate feed, along with the first liquid solvent stream 10. In other embodiments, the first and second CO₂ lean streams 16 and 18 may be directed to the liquid solvent source 111.

The CO₂ lean stream 18, according to one embodiment, may be directed to a heat exchanger (for ex: heat exchanger 150) before being directed to the absorber 110 or the solvent source 111. The heat exchanger 150 is configured to extract heat from the second CO₂ lean stream 18 that leaves the flashing means 140 and direct the cooled CO₂ lean stream to the absorber 110 or the solvent source 111. In one embodiment, the heat exchanger 150 is configured to cool the second CO₂ lean stream 18 to ambient temperature. In some embodiments, a separate heat exchanger is placed along the fluid conduits that couple the second flashing means 140 and either the absorber 110 or the solvent source 111 or both.

Referring again to FIG. 2, in some embodiments, the method includes releasing at least a portion of CO₂ gas bound in the fluid stream 13 to form the first and second CO₂ streams 15 and 17. In some embodiments, the CO₂ streams 15 and 17 may include substantially pure CO₂ gas, and in some embodiments may further include impurities, such as additional absorbed gases or solvent. In some embodiments, the substantially pure CO₂ streams 15 and 17 are released or otherwise directed out of the desorption unit 120 through the discharge outlets 202 and 204. In some embodiments, the CO₂ streams 15 and 17 are compressed or purified, for example, for re-use, or for transport to an end-use location. In some embodiments, the CO₂ streams 15 and 17 may be used for enhanced oil recovery, CO₂ storage, or CO₂ sequestration.

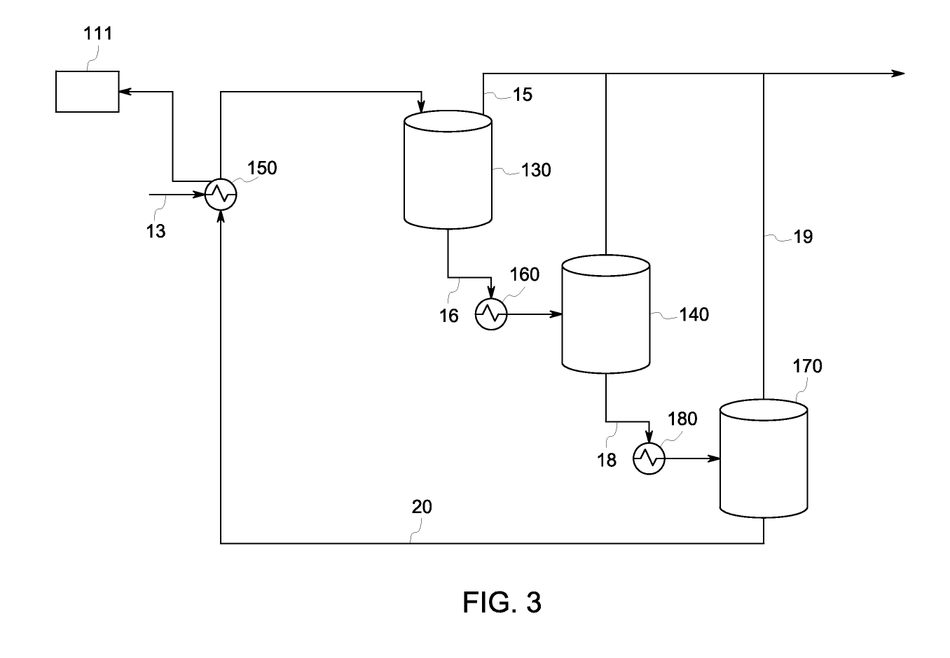

In some embodiments, and as described earlier, a system for separating carbon dioxide (CO₂) from a fluid stream 13 is provided, as indicated in FIGS. 2-3. In some embodiments, the system includes a first flashing means 130 configured to receive the fluid stream 13, as indicated in FIG. 2. The system further includes a second flashing means 140 configured to receive the first CO₂ lean fluid stream 16, as indicated in FIG. 2. As indicated in FIG. 3, the second flashing means 140 may be fluidly coupled to a third flashing means 170 that is configured to receive the second CO₂ lean fluid stream 18 and produce a third CO₂ stream 19 and a third CO₂ lean fluid stream 20. The first, second, and third flashing means 130, 140, and 170 are configured to separate CO₂ from liquid solvent in the fluid stream 13.

In some embodiments that are also illustrated in FIG. 1, the fluid stream 13 is received from an absorber 110 that is configured to react at least a portion of CO₂ in the gas stream 12 with the liquid solvent stream 10 to form the fluid stream 13 and clean gas stream 14. In some embodiments, the system further includes a liquid solvent source 111 in fluid communication with the absorber 110. As discussed earlier, the absorber 110 may be in fluid communication with one or more sources of the gas stream 12 through the inlet 102.

Further, the system illustrated in FIG. 3 also includes a plurality of heat exchangers 150, 160, and 180 that are configured to increase the temperature of the fluid stream 13, the first CO₂ lean fluid stream 16, and the second CO₂ lean fluid stream 18 before they enter the first, second, and third flashing means 130, 140, and 170 respectively. The first heat exchanger 150 is disposed along the fluid conduits that fluidly couple the absorber 110 with the first flashing means 130. Similarly, the second heat exchanger 160 is placed along the fluid conduits that fluidly couple the first flashing means 130 with the second flashing means 140. The third heat exchanger 180 is placed along the fluid conduits that fluidly couple the second flashing means 140 with the third flashing means 170. The temperatures may be selected based on a composition of the liquid solvent in the fluid stream 13 and the volume of CO₂ present in the fluid stream 13, the first CO₂ lean fluid stream 16, and the second CO₂ lean fluid stream 18. In some embodiments, the temperatures are in a range from about 70 degrees Celsius to about 160 degrees Celsius.

Further, in some embodiments, the system may also include cooling and condensing the gas stream using one or more coolers and condensers to form condensed gas streams. In some embodiments, coolers and condensers may also be fluidly coupled with the first, second, and third flashing means 130, 140, and 170 configured to cool the first CO₂ lean fluid stream 16, the second CO₂ lean fluid stream 18, and the third CO₂ lean fluid stream 20. At least a portion of the condensed CO₂ lean fluid streams may be circulated back to the absorber 110 (illustrated in FIG. 1).

As noted earlier, the liquid solvent based CO₂ separation systems advantageously provide for energy-efficient and cost-effective capture of CO₂. In some embodiments, energy may be saved due to the low volatility of aminosiloxane based liquid solvents. Further, the low vapor pressure of the liquid solvent used in the disclosed technique reduces the power requirements in compressing the CO₂ stream exiting the desorption unit since the flashing means can be operated at high temperatures and/or pressures. Furthermore, the solvent utilized does not display corrosive properties and thus reduces the capital cost on material being used to build the absorber. Reduction in corrosion also reduces maintenance costs of the system. The presence of co-solvents in the liquid solvent stream also reduces the viscosity of the working fluid. The mixture of solvents disclosed herein and the co-solvents disclosed also increases the working capacity in comparison with desorption systems that utilized aqueous amine solutions as solvents. This may advantageously result in reduced materials and capital cost, increased efficiency, simplified CO₂ capture process, and a potential reduction in the overall footprint of the system.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method for separating carbon dioxide (CO₂) from a fluid stream comprising CO₂ and a liquid solvent, the method comprising:
receiving the fluid stream at a first flashing means to obtain a first CO₂ stream and a first CO₂ lean fluid stream enriched in the liquid solvent in comparison with the fluid stream; and
receiving the first CO₂ lean fluid stream at a second flashing means to obtain a second CO₂ stream and a second CO₂ lean fluid stream that is enriched in the liquid solvent in comparison with the first CO₂ lean fluid stream.

2. The method of claim 1, further comprising:
receiving a gas stream comprising carbon dioxide in an absorber that is in fluid communication with the first flashing means, wherein the absorber is configured to bring the gas stream into contact with a first liquid solvent stream; and
reacting at least a portion of the CO₂ in the gas stream with the first liquid solvent stream to obtain the fluid stream and a clean gas stream with reduced CO₂ in comparison with the gas stream.

3. The method of claim 2, further comprising directing the second CO₂ lean fluid stream back to the absorber.

4. The method of claim 1, further comprising sequestering a combination of the first CO₂ stream and the second CO₂ stream.

5. The method of claim 1, wherein the liquid solvent comprises an aminosiloxane.

6. The method of claim 1, further comprising heating the fluid stream and the first CO₂ lean stream to a first desired temperature and a second desired temperature respectively before passing the fluid stream and the first CO₂ lean stream into the first flashing means and the second flashing means respectively.

7. The method of claim 1, wherein the first flashing means and the second flashing means are adiabatic.

8. The method of claim 1, further comprising maintaining the pressure at the first flashing means and the second flashing means at a predetermined level.

9. The method of claim 8, wherein the predetermined level comprises ambient pressure.

10. A system for separating carbon dioxide (CO₂) from a fluid stream comprising CO₂ and at least a liquid solvent, the system comprising:
a first flashing means configured to receive the fluid stream and separate the fluid stream to obtain a first CO₂ stream and a first CO₂ lean fluid stream enriched in the liquid solvent in comparison with the fluid stream; and
a second flashing means in fluid communication with the first flashing means and configured to receive the first CO₂ lean fluid stream to separate the first CO₂ lean fluid stream to obtain a second CO₂ stream and a second CO₂ lean fluid stream that is enriched in the liquid solvent in comparison with the first CO₂ lean fluid stream.

11. The system of claim 10 further comprising a first heat exchanger configured to receive the fluid stream and increase the temperature of the fluid stream to a first desired temperature before being introduced in the first flashing means.

12. The system of claim 11, further comprising a second heat exchanger configured to receive the first CO₂ lean stream and increase the temperature of the first CO₂ lean stream to a second desired temperature before being introduced in the second flashing means.

13. The system of claim 10 further comprising an absorber in fluid communication with the first flashing means, and configured to receive a gas stream and a first liquid solvent stream, wherein the absorber is configured to bring the gas stream in contact with the first liquid solvent stream and to produce a cleaned gas stream and the fluid stream.

14. The system of claim 13, further comprising a liquid solvent source in fluid communication with the absorber, the first flashing means, and the second flashing means.

15. The system of claim 13, wherein the absorber further comprises a plurality of fluid conduits in fluid communication with the first flashing means and the second flashing means to receive the first CO₂ lean stream and the second CO₂ lean stream.

16. The system of claim 10, wherein the first flashing means and the second flashing means comprise a vessel.

17. The system of claim 10, wherein the liquid solvent comprises an amino siloxane.

18. A method for separating carbon dioxide (CO₂) from a gas stream comprising CO₂, the method comprising:
contacting a first liquid solvent stream with the gas stream in an absorber, wherein the first liquid solvent stream comprises a liquid solvent;
reacting at least a portion of the CO₂ in the gas stream with the first liquid solvent stream to obtain a fluid stream and a clean gas stream with reduced CO₂ in comparison with the gas stream, wherein the fluid stream comprises CO₂ and the liquid solvent;
heating the fluid stream in a first flashing means that is in fluid communication with the absorber to obtain a first CO₂ stream and a first CO₂ lean fluid stream enriched in the liquid solvent in comparison with the fluid stream; and
heating the first CO₂ lean fluid stream in a second flashing means that is in fluid communication with the first flashing means to obtain a second CO₂ stream and a second CO₂ lean fluid stream that is enriched in the liquid solvent in comparison with the first CO₂ lean fluid stream.

19. The method of claim 18, further comprising directing the second CO₂ lean fluid stream back to the absorber.

20. The method of claim 18, further comprising heating the fluid stream and the first CO₂ lean stream to a first desired temperature and a second desired temperature, respectively, before passing the fluid stream and the first CO₂ lean stream into the first flashing means and the second flashing means, respectively.
